(19) United States
(12) Patent Application Publication
(10) Pub. No.: US 2009/0085928 A1
(43) Pub. Date: Apr. 2, 2009

(54) ANTIALIASING USING MULTIPLE DISPLAY HEADS OF A GRAPHICS PROCESSOR

(75) Inventors: Duncan A. Riach, East Sussex (GB); Brijesh Tripathi, Santa Clara, CA (US); Brett T. Hannigan, Menlo Park, CA (US); Philip Browning Johnson, Campbell, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: NVIDIA Corporation, Santa Clara, CA (US)

(21) Appl. No.: 11/680,554

(22) Filed: Feb. 28, 2007

Related U.S. Application Data
(60) Provisional application No. 60/747,154, filed on May 12, 2006.

(51) Int. Cl. G09G 5/00

(52) U.S. Cl. 345/615

(57) ABSTRACT

Multiple display heads of a single graphics processor are exploited to perform antialiasing and other processing tasks. In one embodiment, two display heads of the same graphics processor are coupled to each other in a master/slave configuration via a pixel transfer path. The “master” display head receives pixels from the “slave” display head in addition to its own pixels, and pixel selection logic in the master display head can blend the two pixels or select either one to the exclusion of the other. If the two pixels correspond to different sampling locations in the same display pixel, the blended pixel is an antialiased pixel.

### CROSS-REFERENCES TO RELATED APPLICATIONS

This application claims the benefit of U.S. Provisional Application No. 60/747,154, filed May 12, 2006, entitled “Antialiasing Using Multiple Display Heads of a Graphics Processor,” which disclosure is incorporated herein by reference for all purposes.

The present disclosure is related to commonly-assigned co-pending U.S. patent application Ser. No. 11/383,048, filed May 12, 2006, entitled “Distributed Antialiasing in a Multiprocessor Graphics System,” which disclosure is incorporated herein by reference for all purposes.

### BACKGROUND OF THE INVENTION

The present invention relates in general to computer graphics, and in particular to antialiasing of image data using multiple display heads of a graphics processor.

As is known in the art, computer-generated images are susceptible to various visual artifacts resulting from the finite sampling resolution used in converting the image data to an array of discrete color samples (pixels). Such artifacts, generally referred to as “aliasing,” include jaggedness in smooth lines, irregularities in regular patterns, and so on.

To reduce aliasing, color is often “oversampled,” i.e., sampled at a number of sampling locations that exceeds the number of pixels making up the final (e.g., displayed or stored) image. For instance, an image might be sampled at twice or four times the number of pixels. Various types of oversampling are known in the art, including supersampling, in which each sampling location is treated as a separate pixel, and multisampling, in which a single color value is computed for each primitive that covers at least part of the pixel, but coverage of the pixel by the primitive is determined at multiple locations.

An antialiasing (AA) filter blends the multiple samples per pixel to determine a single color value. Conventionally, AA filters are applied either within the rendering pipeline that generates pixels and stores them to a frame buffer or within the display pipeline that reads pixels from the frame buffer and delivers them to a display device.

### BRIEF SUMMARY OF THE INVENTION

Embodiments of the present invention provide systems and methods for exploiting multiple display heads of a single graphics processor to perform antialiasing and other processing tasks. In one embodiment, two display heads of the same graphics processor are coupled to each other in a master/slave configuration via a pixel transfer path. The “master” display head receives pixels from the “slave” display head in addition to its own pixels, and pixel selection logic in the master display head can blend the two pixels or select either one to the exclusion of the other. If the two pixels correspond to different sampling locations in the same image, the blended pixel is an AA-filtered pixel.

According to one aspect of the present invention, a graphics processing device includes a first display head, a second display head, and a pixel transfer path. The first display head is configured to generate a first output pixel and is disposed within an integrated circuit. The second display head, which is configured to generate a second output pixel, is also disposed within the integrated circuit. The second display head advantageously includes a first input path configured to receive an external pixel; a second input path configured to receive an internal pixel; a pixel combiner coupled to the first input path and the second input path and configured to blend the external pixel and the internal pixel to generate a blended pixel; and a selection circuit configured to select one of the external pixel, the internal pixel, or the blended pixel as a second output pixel. The pixel transfer path is configurable to deliver the first output pixel from the first display head to the first input path of the second display head such that the first output pixel is received by the first input path as the external pixel.

In some embodiments, the pixel transfer path is also disposed within the integrated circuit. In other embodiments, at least a portion of the pixel transfer path is external to the integrated circuit. For instance, the pixel transfer path may include a removable connector.

According to another aspect of the present invention, a graphics subsystem includes a graphics adapter having a pixel output connector and a pixel input connector. A graphics processor, which may be mounted on the graphics adapter, has a pixel output port communicably coupled to the pixel output connector and a pixel input port communicably coupled to the pixel input connector. The graphics subsystem also includes a removable connector unit adapted to connect the pixel output connector of the graphics adapter to the pixel input connector of the graphics adapter.

According to still another aspect of the present invention, a method of generating an image includes rendering a first set of input pixels and a second set of input pixels for the image using a rendering pipeline of a graphics processor. A first rendering operation used to render the first set of input pixels differs in at least one respect from a second rendering operation used to render the second set of input pixels; for instance, the two rendering operations may differ with respect to a sampling pattern applied to each pixel or with respect to a viewport offset of the image being rendered. The first set of input pixels is delivered to a first display head of the graphics processor, and the second set of input pixels is delivered to a second display head of the graphics processor. The first set of input pixels is further delivered from the first display head to the second display head. In the second display head, corresponding pixels of the first set of input pixels and the second set of input pixels are blended to generate a set of output pixels.

The following detailed description together with the accompanying drawings will provide a better understanding of the nature and advantages of the present invention.

### BRIEF DESCRIPTION OF THE DRAWINGS

FIG. 1 is a block diagram of a computer system according to an embodiment of the present invention;

FIG. 2 is a block diagram of a pixel output path in a graphics processing unit (GPU) usable in an embodiment of the present invention;

FIG. 3 is a block diagram of pixel selection logic in a display head of a GPU usable in an embodiment of the present invention;

FIG. 4 is a block diagram of a GPU showing two display heads coupled in a master/slave configuration according to an embodiment of the present invention;

FIGS. 5A-5C illustrate sampling patterns usable in some embodiments of the present invention;

FIG. 6 illustrates a graphics adapter implemented as a printed circuit card and configured with an external pixel transfer path according to an embodiment of the present invention; and

FIG. 7 is a block diagram of a GPU with an internal pixel transfer path according to an embodiment of the present invention.

### DETAILED DESCRIPTION OF THE INVENTION

Embodiments of the present invention provide systems and methods for exploiting multiple display heads of a single graphics processor to perform antialiasing and other processing tasks. In one embodiment, two display heads of the same graphics processor are coupled to each other in a master/slave configuration via a pixel transfer path. The “master” display head receives pixels from the “slave” display head in addition to its own pixels, and pixel selection logic in the master display head can blend the two pixels or select either one to the exclusion of the other. If the two pixels correspond to different sampling locations in the same image, the blended pixel is an AA-filtered pixel.

### System Overview

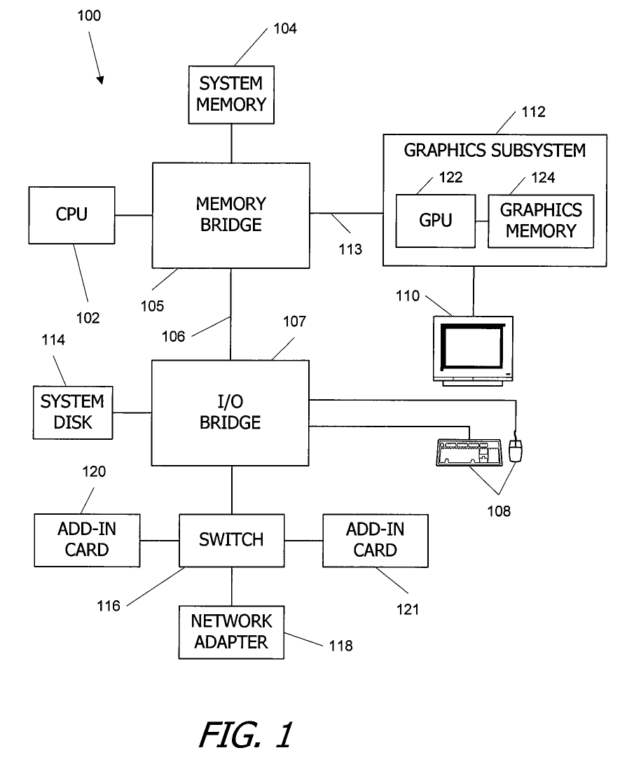

FIG. 1 is a block diagram of a computer system 100 according to an embodiment of the present invention. Computer system 100 includes a central processing unit (CPU) 102 and a system memory 104 communicating via a bus path that includes a memory bridge 105, e.g., a Northbridge chip. Memory bridge 105 is connected via a bus or other communication path 106 to an I/O (input/output) bridge 107, e.g., a Southbridge chip. I/O bridge 107 receives user input from one or more user input devices 108 (e.g., keyboard, mouse) and forwards the input to CPU 102 via bus 106 and memory bridge 105. Visual output is provided on a pixel based display device 110 (e.g., a conventional CRT or LCD based monitor) operating under control of a graphics subsystem 112 coupled to memory bridge 105 via a bus or other communication path 113. A system disk 114 is also connected to I/O bridge 107. A switch 116 provides connections between I/O bridge 107 and other components such as a network adapter 118 and various add-in cards 120, 121. Other components (not explicitly shown), including USB or other port connections, CD drives, DVD drives, and the like, may also be connected to I/O bridge 107. Communication paths among the various components may be implemented using protocols such as PCI (Peripheral Component Interconnect), PCI Express (PCI-E), AGP (Accelerated Graphics Port), HyperTransport, or any other bus or point-to-point protocol(s), and connections between different devices may use different protocols as is known in the art.

Graphics processing subsystem 112 includes a graphics processing unit (GPU) 122 and a graphics memory 124, which may be implemented, e.g., using one or more integrated circuit devices such as programmable processors, application specific integrated circuits (ASICs), and memory devices. GPU 122 may be configured to perform various tasks related to generating pixel data from graphics data supplied by CPU 102 and/or system memory 104 via memory bridge 105 and path 113, interacting with graphics memory 124 to store and update pixel data, and the like. For example, GPU 122 may generate pixel data from 2-D or 3-D scene data provided by various programs executing on CPU 102. GPU 122 may also store pixel data received via memory bridge 105 to graphics memory 124 with or without further processing. GPU 122 also includes a scanout module configured to deliver pixel data from graphics memory 124 to display device 110.

CPU 102 operates as the master processor of system 100, controlling and coordinating operations of other system components. In particular, CPU 102 issues commands that control the operation of GPU 122. In some embodiments, CPU 102 writes a stream of commands for GPU 122 to a command buffer, which may be in system memory 104, graphics memory 124, or another storage location accessible to both CPU 102 and GPU 122. GPU 122 reads the command stream from the command buffer and executes commands asynchronously with operation of CPU 102. The commands may include conventional rendering commands for generating images as well as general-purpose computation commands that enable applications executing on CPU 102 to leverage the computational power of GPU 122 for data processing that may be unrelated to image generation.

It will be appreciated that the system shown herein is illustrative and that variations and modifications are possible. The interconnection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, graphics subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

The connection of GPU 122 to the rest of system 100 may also be varied. In some embodiments, graphics system 112 is implemented as an expansion, or add-in, card that can be inserted into an expansion slot of system 100. In other embodiments, a GPU is integrated on a single chip with a bus bridge, such as memory bridge 105 or I/O bridge 107.

A GPU may be provided with any amount of local graphics memory, including no local memory, and may use local memory and system memory in any combination. For instance, in a unified memory architecture (UMA) embodiment, no dedicated graphics memory device is provided, and the GPU uses system memory exclusively or almost exclusively. In UMA embodiments, the GPU may be integrated into a bus bridge chip or provided as a discrete chip with a high-speed bus (e.g., PCI-E) connecting the GPU to the bridge chip and system memory.

It is also to be understood that any number of GPUs may be included in a system, e.g., by including multiple GPUs on a single graphics card or by connecting multiple graphics cards to path 113. Multiple GPUs may be operated in parallel to generate images for the same display device or for different display devices. Each GPU in a multi-GPU graphics system may or may not have an associated graphics memory.

In addition, GPUs embodying aspects of the present invention may be incorporated into a variety of devices, including general purpose computer systems, video game consoles and other special purpose computer systems, DVD players, handheld devices such as mobile phones or personal digital assistants, and so on.

GPU with Multiple Display Heads

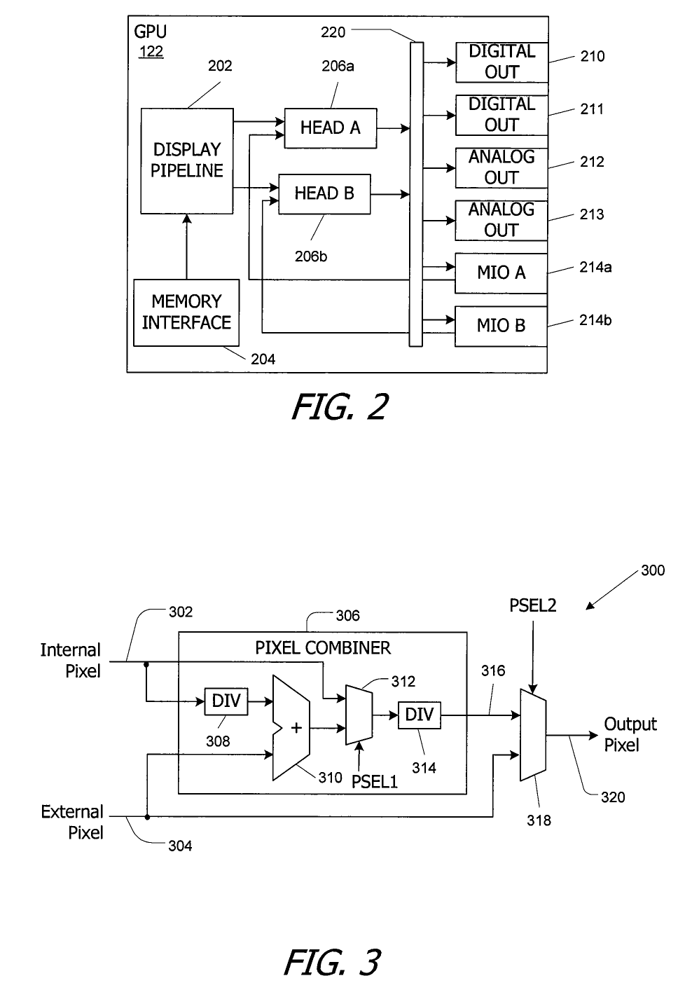

FIG. 2 is a block diagram of a pixel output path in a GPU 122 usable to practice the present invention. Although a multi-GPU graphics system is not required for the present invention, GPU 122 is advantageously configured to be usable in such a system.

In particular, as shown in FIG. 2, GPU 122 includes a display (or scanout) pipeline 202 coupled to a memory interface 204. Display pipeline 202 is also coupled to display heads 206a (“head A”) and 206b (“head B”). GPU 122 has multiple output ports 210-213, including digital output ports 210, 211, and analog output ports 212, 213. GPU 122 also has two multipurpose input/output (MIO) ports 214a (“MIO A”) and 214b (“MIO B”) that are configurable for various purposes, including communication with another GPU or with another external digital device. Display heads 206a and 206b are each coupled to output ports 210-213 and MIO ports 214a, 214b via a crossbar 220.

Memory interface 204 is coupled to a memory (not shown in FIG. 2), e.g., graphics memory 124 of FIG. 1, that stores pixel data generated by GPU 122. Display pipeline 202 communicates with memory interface 204 to access the stored pixel data. Display pipeline 202 delivers the pixel data to either or both of display heads 206a, 206b. In some embodiments, display pipeline 202 may perform various processing operations on the pixel data before delivering it to display heads 206a, 206b, and pixel data destined for display head 206a might or might not be processed differently from pixel data destined for display head 206b. In addition, pixel data provided to display pipeline 202 for processing and delivery to display head 206a may be the same as or different from the pixel data provided to display pipeline 202 for processing and delivery to display head 206b. The particular configuration of display pipeline 202 and memory interface 204 is not critical to the present invention, and a detailed description is omitted.

Digital output ports 210, 211 may be of generally conventional design and may include circuits that modify the pixel data to conform to a digital output standard. For instance, in one embodiment, each of ports 210, 211 implements TMDS (Transition Minimized Differential Signaling) for a standard DVI (Digital Video Interface) connector. Similarly, analog output ports 212, 213 can be of generally conventional design and may include, e.g., a digital to analog converter conforming to any analog video standard, numerous examples of which are known in the art. It will be appreciated that the presence, absence, number, or nature of particular digital or analog output ports is not critical to the present invention.

MIO A port 214a and MIO B port 214b can be configured as output ports that drive pixel data produced by either of display heads 206a, 206b onto output lines of GPU 122. MIO A port 214a and MIO B port 214b can also be configured as input ports that deliver external pixel data to display head A 206a or display head B 206b. In some embodiments, MIO A port 214a and MIO B 214b are each independently configurable as either an input port or an output port. The configuration of MIO A port 214a and MIO B port 214b may be determined during system startup or dynamically modified at various times during system operation. For instance, each MIO port may include a control register that stores a value specifying the port configuration, and a new value may be written to the register at system startup or at other times as desired.

Head A 206a and head B 206b are each coupled to output ports 210-213, as well as to MIO ports 214a, 214b via crossbar 220. In this embodiment, crossbar 220 is configurable to support any connection from head A 206a to any one of ports 210-213, 214a, or 214b and to simultaneously support any connection from head B 206b to any one of ports 210-213, 214a, or 214b that is not currently connected to head A 206a by crossbar 220. For instance, GPU 122 can simultaneously drive pixel data from heads 206a, 206b to two different monitors (e.g., via any two of digital output ports 210, 211 and/or analog output ports 212, 213). Alternatively, GPU 122 can simultaneously drive pixels to a monitor via one of output ports 210-213 and to another GPU via MIO A port 214a or MIO B port 214b. In some instances, one or both of display heads 206a, 206b may be idle, i.e., not delivering pixels to any output port.

MIO ports 214a, 214b can also be configured to receive pixel data from another one of GPUs 122 and to communicate the received pixel data into display heads 206a, 206b. Each GPU 122 also has pixel selection logic (described below) in each display head 206a, 206b to select an “external” pixel received from one of MIO ports 214a, 214b, an “internal” pixel received from its own display pipeline 202, or a combination of the internal and external pixels.

In some embodiments, crossbar 220 is configured at system startup; in other embodiments, crossbar 220 is dynamically configurable, so that the connections can be changed during system operation. Crossbar 220 may also be configurable to couple incoming pixel data received at one of MIO ports 214a, 214b to either of display heads 206a, 206b.

FIG. 3 is a block diagram of pixel selection logic 300 in display head 206a of a GPU 122 according to an embodiment of the present invention. It is to be understood that display head 206b may have pixel selection logic of similar design. In some embodiments, each display head 206a, 206b of GPU 122 has its own pixel selection logic 300.

Pixel selection logic 300 receives an internal pixel on a first path 302 from display pipeline 202 of FIG. 2. When MIO A port 214a of FIG. 2 (or in some embodiments, MIO B port 214b) is configured as an input port, pixel selection logic 300 also receives an external pixel on a second path 304.

The external pixel and the internal pixel are each propagated to a pixel combiner circuit 306, which blends the external pixel and the internal pixel to produce a blended pixel. Pixel combiner circuit 306 may be implemented, e.g., using conventional arithmetic logic circuits. In one embodiment, pixel combiner circuit 306 includes a first division circuit 308 that divides the internal pixel by one of a number of candidate divisors (e.g., 1, 2, 4, etc.); an addition circuit 310 that adds the internal pixel (after dividing) to the external pixel to produce a sum pixel; a selection circuit 312 that selects between the internal pixel and the sum pixel in response to a control signal (PSEL1); and a second division circuit 314 that divides the selected pixel by one of a number of candidate divisors (e.g., 1, 2, etc.), providing the result as a blended pixel on a path 316.

The external pixel on path 304 and the blended pixel on path 316 are presented to a selection circuit 318 (e.g., a multiplexer). In response to a control signal (PSEL2), selection circuit 318 selects either the internal pixel, the blended pixel, or the external pixel for delivery to an output path 320 that connects to crossbar 220 of FIG. 2.

The PSEL1 and PSEL2 signals are advantageously generated by control logic (not explicitly shown) in display head 206a. In some embodiments, this control logic, which may be of generally conventional design, is responsive to control information generated by a graphics driver program executing on CPU 102 of FIG. 1. Similar control information may also be used to control operation of pixel combiner 308, e.g., by selecting among candidate divisors for division circuits 308, 314 to produce a suitably weighted average for a particular application. Those skilled in the art with access to the present teachings will be able to implement suitable control logic for generating PSEL and pixel combiner control signals; accordingly, a detailed description of the control logic is omitted.

GPU 122 of FIG. 2 with pixel selection logic 300 is advantageously usable for a “distributed antialiasing” operation in a system with two or more GPUs 122, as described in above-referenced application Ser. No. ______ (Attorney Docket No. 019680-022300US). For example, two GPUs 122 may be coupled in a master/slave readout configuration. In one such configuration, the slave GPU 122 have its MIO A port 214a configured as an output port while the master GPU 122 has its MIO A port 214a configured as an input port. The two GPUs are coupled such that pixels can be transferred from the slave GPU to the master GPU.

In a distributed antialiasing (AA) operation, respective rendering pipelines in the master GPU and slave GPU each render an image of the same scene, with some variation in a viewing parameter or sampling parameter such that the sampling locations used by the master GPU are different from the sampling locations used by the slave GPU. For example, slightly different viewports or viewplane normals might be defined for the two GPUs, creating small offsets in the pixel boundaries of the two images. Alternatively, where the sampling location within a pixel is configurable (e.g., by the graphics driver), each GPU might be configured to use the same set of viewing parameters but a different sampling location within each pixel.

The slave GPU forwards its internal pixels (P_{S}) to the slave GPU's MIO A port, from which the pixels P_{S} are transferred to the MIO A port of the master GPU. The MIO A port 214a of the master GPU 122 forwards the pixels (via crossbar 220) to display head A 206a. In parallel, display pipeline 202 of the master GPU 122 forwards internal pixels (P_{M}) from the image rendered by the master GPU to display head A 206a. In a distributed AA mode, the slave pixels P_{S} and master pixels P_{M} received by pixel selection logic 300 in display head 206a of master GPU 122 correspond to different sampling locations for the same pixel of the final image.

Within display head A 206a, pixel selection logic 300 operates to select the blended pixels. In one embodiment, pixel combiner 308 computes the average (P_{S}+P_{M})/2 and provides this average as the blended pixel on path 316. Selection circuit 318 selects the blended pixel on path 316 as the output pixel. Averaging the master and slave pixels provides antialiasing at twice the display resolution. In this manner, pixel selection logic 300 can implement a 2×AA filter.

It will be appreciated that the display heads, pixel selection logic, and distributed AA operations described herein are illustrative and that variations and modifications are possible. For example, the division circuits referred to herein support division by a small number of discrete divisors. In other embodiments, the division circuits might support a larger number of divisors (including arbitrarily selected divisors) so that a broad range of antialiasing filters can be supported. Further, the division circuits may be placed at different locations from those described herein, and the number of division circuits may be modified. For instance, a division circuit might be placed on the external pixel path in addition to or instead of the internal pixel path.

In addition, pixel combiner 308 may also be configurable to perform other types of blending operations. For example, pixel combiner 308 may blend two gamma corrected pixels (i.e., pixels that have been modified to account for non-linearity in the color-intensity response of the display device). In one such embodiment, for γ≈2.2, a gamma-corrected output pixel Pₒ^{γ} can be computed using the equation:

Pₒ^{γ}=(4Pᵢ^{γ}+4Pₑ^{γ}+|Pᵢ^{γ}−Pₑ^{γ}|)/4, (Eq. 1)

where Pᵢ^{γ} and Pₑ^{γ} represent gamma-corrected pixels supplied on paths 302 and 304. Those skilled in the art will recognize that Eq. 1 provides an acceptable approximation using simpler hardware than computing an exact result would require. (For instance, multiplication and division by 4 can be implemented as bit shifts.) It will also be appreciated that other approximations may be substituted.

The particular configuration of selection circuit 318 may also be modified. Those skilled in the art will recognize that any circuit element or combination of circuit elements capable of controllably selecting among the internal pixel, the external pixel, and a blended pixel derived from both the internal and external pixel may be used as a selection circuit.

Further embodiments of pixel selection logic suitable for practicing the present invention are described in above-referenced application Ser. No. ______ (Attorney Docket No. 019680-022300US); it is to be understood that these embodiments are also illustrative and not limiting of the present invention.

As used herein, a “pixel” refers generally to any representation of a color value sampled at some location within an image, or to a combination of such values (e.g., as produced by addition circuit 308 of FIG. 3). Rendering pipelines in the GPUs generate pixels at a nominal resolution (where resolution refers to the number of pixels in the image), which might or might not coincide with the resolution of the display device. In some embodiments, the display pipeline performs any needed up-filtering or down-filtering to transform the nominal resolution to the display resolution.

The labeling of MIO ports and display heads herein as “A” and “B” herein is solely for convenience of description. It is to be understood that any MIO port can be connected to any other MIO port, and either display head can drive either MIO port when that port is configured as an output port. In addition some GPUs may include more or fewer than two MIO ports and/or more or fewer than two display heads.

In general, any port or ports that enable one GPU to communicate pixel data with another GPU may be used as I/O ports to practice the present invention. In some embodiments, the MIO ports are also reconfigurable for purposes other than communicating with another GPU, as noted above. For instance, the MIO ports can be configured to communicate with various external devices such as TV encoders or the like; in some embodiments, DVO (Intel Corporation's Digital Video Output Interface) or other standards for video output can be supported. In some embodiments, the configuration of each MIO port is determined when a graphics adapter is assembled; at system startup, the adapter notifies the system as to the configuration of its MIO ports. In other embodiments, the MIO ports may be replaced with dedicated input or output ports.

Configuration of I/O ports, display heads, and other aspects of a graphics subsystem may be accomplished by a system setup unit configured to communicate with all of the graphics processors. In some embodiments, the system setup unit is implemented in a graphics driver program that executes on a CPU of a system that includes a multi-processor graphics subsystem. Any other suitable agent, including any combination of hardware and/or software components, may be used as a system setup unit.

### Internally Distributed Antialiasing

In accordance with an embodiment of the present invention, the two display heads 206a, 206b of one GPU 122 may be coupled to each other in a master/slave configuration. In this configuration, GPU 122 can perform “internally distributed” AA filtering using pixel selection logic 300 in the display head (e.g., head A 206a) that is operating as the master.

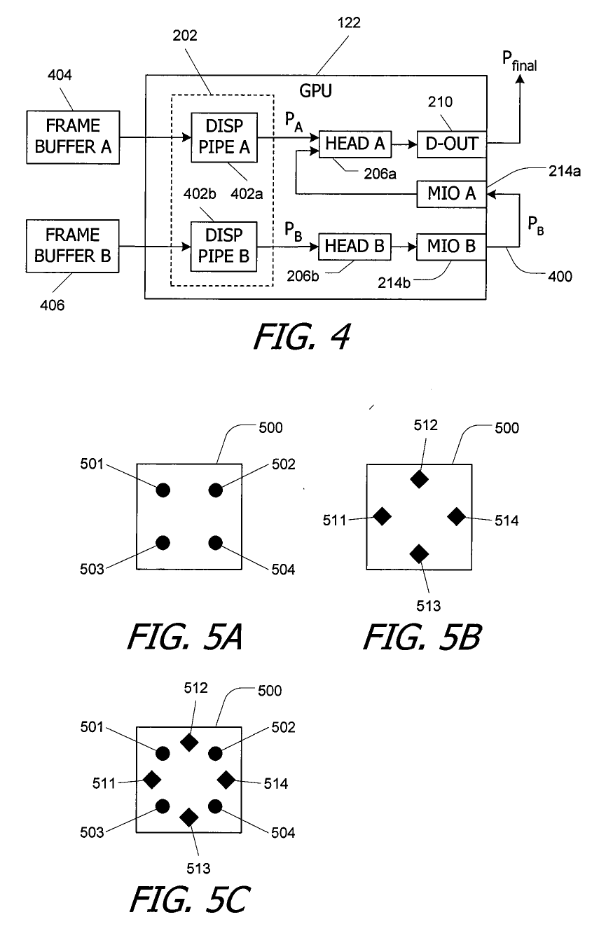

FIG. 4 is a block diagram of a GPU 122 showing display head 206a coupled to display head 206b in a master/slave configuration according to an embodiment of the present invention. It is to be understood that GPU 122 of FIG. 4 may be identical to GPU 122 of FIG. 2; in FIG. 4, only the active I/O ports are shown, and crossbar 220 is not shown. Display pipeline 202 in FIG. 4 is shown as having two parallel sections: display pipeline A 402a, which delivers pixels to display head 206a, and display pipeline B 402b, which delivers pixels to display head 206b. Display pipelines A 402a and B 402b may each be of generally conventional design, and each may be configured to perform various pixel processing operations; the two display pipelines 402a, 402b may perform the same operations or different operations, as desired.

MIO B port 214b is coupled, via a pixel transfer path 400, to MIO A port 214a of the same GPU 122. Pixel transfer path 400 transfers pixels produced by display head B 206b from MIO B port 214b to MIO A port 214a; MIO A port 214a delivers the pixels it receives to display head A 206a of GPU 122. Pixel transfer path 400 may be implemented using any suitable signal transfer techniques; examples are described below.

From the perspective of display head A 206a, the pixels received from display head B 206b are indistinguishable from pixels received from a different GPU. Thus, for instance, pixel selection logic 300 in display head A 206a can be operated to select, as an output pixel, any one of an “internal” pixel (P_{A}) originating from head A206a, an “external” pixel (P_{B}) originating from head B 206b, or a blended pixel created from pixels P_{A} and P_{B} by pixel combiner circuit 308. (Pixels P_{B} are “external” to display head A 206a in the sense that, unlike pixels P_{A}, pixels P_{B} are not provided to display head A 206a by display pipeline A 402a.)

In this configuration, GPU 122 is usable to perform “internally distributed” AA, with the two display pipelines 402a, 402b supplying sample values that are blended by pixel selection logic 300 in display head A 206. In operation, a rendering pipeline (not explicitly shown) of GPU 122 renders two images of the same scene, with some variation in a viewing parameter or sampling parameter such that the sampling locations used for the two images are different from each other. For example, slightly different viewports or viewplane normals might be defined for the two images, creating small offsets in the pixel boundaries of the two images. Alternatively, where the sampling location within a pixel is configurable (e.g., by the graphics driver), each image might be generated using the same set of viewing parameters but a different sampling location within each pixel.

One of the rendered images is stored in a frame buffer “A” 404 while the other is stored in a frame buffer “B” 406. Frame buffers A 404 and B 406 may be implemented in any memory device or devices, including on-chip memory in GPU 122, graphics memory 124 and/or system memory 104 of FIG. 1; the two frame buffers may be located in the same memory device or different devices as desired.

Display pipeline B 402b reads pixels from frame buffer B 406, performs various processing operations (which may be of a generally conventional nature) on the pixels, and forwards the resulting pixels P_{B} to display head B 206b. Display head B 206b has pixel selection logic 300 that operates to select pixels P_{B}; those pixels are forwarded to MIO B port 214b via crossbar 220 (not explicitly shown in FIG. 4). Pixels P_{B} are transferred via pixel path 400 to MIO A port 214a of the same GPU 122, which forwards the pixels P_{B} to display head A 206a.

In parallel with this operation, display pipeline A 206a reads pixels from frame buffer A, performs various processing operations (which may be of a generally conventional nature) on the pixels, and forwards the resulting pixels P_{A} to display head A 206a. Display pipeline B 402b, display head B 206b, and pixel transfer path 400 are advantageously configured with appropriate timing so that pixel values P_{A} and P_{B} corresponding to the same screen pixel are delivered at the same time (e.g., in the same clock cycle) to pixel selection logic 300 of display head A 206a.

Within pixel combiner circuit 308, addition circuit 310 adds pixels P_{A} and P_{B}, multiplexer 312 selects the sum pixel, and division circuit 314 divides the sum by 2; thus, the blended pixel on path 316 is the average of pixels P_{A} and P_{B}. Multiplexer 318 selects the blended pixel as an output pixel P_{final}. Display head A 206a delivers the output pixel P_{final} to an output port (e.g., digital output port 210) for transmission to a display device.

It should be noted that because the rendering pipeline of GPU 122 renders each frame twice, the maximum frame rate for GPU 122 when operating in the internally distributed AA mode described herein is generally lower than the maximum frame rate when operating in a non-AA mode. In some embodiments, the frame rate for this internally distributed AA mode is approximately half the frame rate for the non-AA mode. For real-time animation, as long as the frame rate for the internally distributed AA mode is around 30 frames per second (or higher), the reduction in frame rate has little or no detrimental effect on the smoothness of the animation. Further, the image quality produced in a non-AA mode will generally be lower than image quality produced in an internally distributed AA mode; thus, internally distributed AA trades off a reduced frame rate for higher image quality.

It should also be noted that frame rates obtainable using the internally distributed AA mode described herein are comparable to frame rates obtainable using conventional AA techniques (e.g., filtering in the rendering pipeline and/or the display pipeline) in a single GPU. Conventional AA with a single GPU requires the GPU's rendering pipeline to generate a single image, but with multiple samples per pixel. Processing a larger number of samples per pixel generally also decreases frame rate relative to non-AA modes in exchange for improved image quality. Depending on how the rendering of dual images is managed in the rendering pipeline, throughput of a GPU with internally distributed AA may be comparable to throughput of a GPU with conventional AA.

Higher-order AA filters may also be implemented, and such filters may employ a combination of single-pipeline and internally distributed antialiasing operations. In one embodiment, display pipeline A 402a and display pipeline B 402b each include a filter-on-scanout (FOS) module (not explicitly shown) that implements an internal Nx AA filter. More specifically, for each version of the image that is rendered, the rendering pipeline in GPU 122 generates a number N (e.g., 2, 4 or any other number larger than 1) of samples per pixel, e.g., using conventional supersampling and/or multisampling techniques. The samples for one version of the image are stored in frame buffer A 404, while the samples for the other version of the image are stored in frame buffer B 406.

Display pipeline 402a receives all Nsamples for each pixel from frame buffer A. Within display pipeline 402a, a first filter-on-scanout (FOS) module (not explicitly shown in FIG. 4) implements an Nx AA filter, blending the N samples to produce a single color value per pixel. The color value determined by the FOS module is supplied (possibly after further processing) to display head A 206a as a pixel P_{A}.

Similarly, display pipeline 402b receives all N samples for each pixel from frame buffer B 406. Within display pipeline 402b, a second FOS module (also not explicitly shown in FIG. 4) implements an Nx AA filter, blending the N samples to determine a single color value per pixel. The color value determined by the second FOS module is supplied (possibly after further processing) to display head B 206b as a pixel P_{B}.

Thus, the pixels P_{A} and P_{B} produced by display pipes 402a and 402b, respectively, can each be filtered pixels from an Nx-oversampled image. As long as the sampling points used to populate frame buffer A 404 do not coincide with those used to populate frame buffer B 406, combining an Nx AA filter in each display pipe 402a, 402b with the internally distributed AA filter technique described above results in a (2N)x AA filter. For instance, if the FOS module in each display pipe 402a, 402b provides a 4x AA filter, then GPU 122 can provide 8x AA.

A particular FOS module or AA filtering algorithm is not critical to the present invention, and conventional modules and algorithms may be used. Accordingly, a detailed description has been omitted. In some embodiments, the FOS modules in display pipelines 402a and 402b apply identical filter algorithms so that the resulting final image is not dependent on which version of the image is processed by a particular display pipeline. Further, Nx AA filtering can be performed earlier in the image generation process. For instance, in one alternative embodiment, Nx AA filtering might be performed within the rendering pipeline of GPU 122 using conventional techniques.

In some embodiments, the sampling points used to populate different frame buffers are selected such that no two sampling points coincide. For example, FIG. 5A illustrates a “grid” sampling pattern applied to a pixel 500. The pixel is sampled four times, at locations 501-504 (indicated by circles) within the pixel. FIG. 5B illustrates a “rotated grid” sampling pattern applied to pixel 500. The pixel is sampled four times, locations 511-514 (indicated by diamonds), which are different from locations 501-504.

In one embodiment, pixel data in frame buffer A 404 is generated using the grid sampling pattern of FIG. 5A while pixel data in frame buffer B 406 is generated using the rotated grid sampling pattern of FIG. 5B. The FOS module in display pipe A 402a filters the four sample values (501-504) to a single value P_{A}, while the FOS module in display pipe B 402b filters the four sample values (511-514) to a single value P_{B}. Pixel selection logic 300 in display head 206a blends the values P_{A} and P_{B} as described above to obtain a final pixel value that corresponds to an average over all eight samples. This procedure provides the same antialiasing power as a single rendering process that samples each pixel with the eight-point pattern illustrated in FIG. 5C.

It will be appreciated that the internally distributed AA technique described herein is illustrative and that variations and modifications are possible. For instance, GPU 122 as described herein has exactly two display heads, each of which is capable of driving at most one output port; consequently, when both display heads are used for internally distributed antialiasing, GPU 122 can deliver at most one pixel stream to the display device(s). However, embodiments of the present invention may be implemented in any GPU that has at least two display heads and suitable pixel selection logic and I/O ports. Where the GPU has more than two display heads, the GPU can support internally distributed AA and can also supply independent pixel streams to two or more display devices. Additionally, where the GPU has more than two display heads, it may be possible to connect all of the GPU's display heads together in a master/slave daisy chain to further increase the AA power of the GPU.

Further, GPU 122 as described herein has two MIO ports, both of which are used for internally distributed AA. In this embodiment, neither head A 206a nor head B 206b would be usable as a master or slave to any other GPU or display head. In other embodiments, the GPU may have additional MIO ports or the MIO ports may have an operating mode that allows one port to receive pixels and send pixels at the same time, allowing interconnectivity with other GPUs in combination with internally distributed AA. For example, where a third MIO port is present, that port might be configured as an input port to deliver external pixels from another GPU to display head B 206b or as an output port to deliver pixels produced by display head A 206a to another GPU. The other GPU in such an embodiment might or might not be configured to perform its own internally distributed AA filtering.

### Pixel Transfer Path

Examples of pixel transfer path implementations according to embodiments of the present invention will now be described. As will become clear, the pixel transfer path may be external or internal to the GPU.

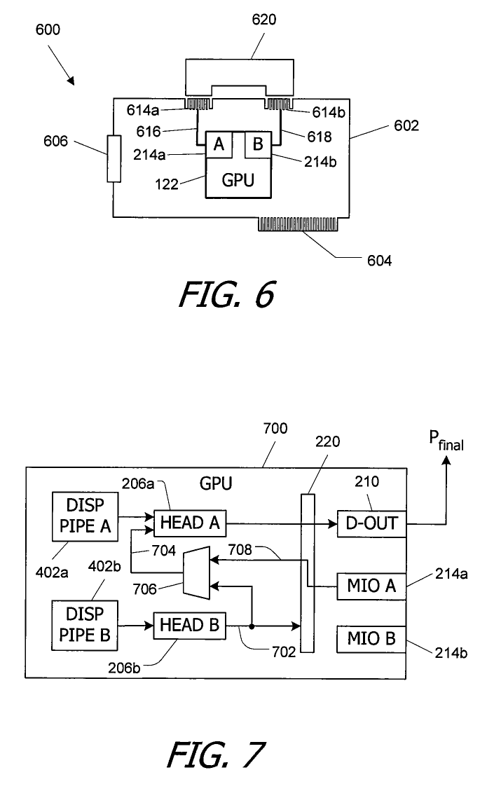

FIG. 6 illustrates a graphics adapter 600 implemented as a printed circuit card and configured with an external pixel transfer path according to an embodiment of the present invention. Graphics adapter 600 is implemented as an expansion card using a printed circuit board (PCB) 602 that conforms to PCI-E or another interconnection standard. GPU 122 is mounted on PCB 602 and electrically coupled to a system connector 604 via wire traces (not shown) on PCB 602. System connector 604 is designed to be inserted into a PCI-E expansion slot (or any other type of expansion slot), enabling communication between GPU 122 and the rest of a computer system such as system 100 of FIG. 1. GPU 122 is also electrically coupled to a display output connector 606 via wire traces (not shown) on PCB 602. Display output connector 606 is advantageously coupled to one of digital output ports 210, 211 or analog output ports 212, 213 of GPU 122 (see FIG. 2). In some embodiments, PCB 602 may provide multiple display output connectors 606, each coupled to a different one of output ports 210-213, as is known in the art.

PCB 602 also includes two graphics edge connectors 614a, 614b, which can be of identical design. Graphics edge connector 614a connects to MIO A port 214a of GPU 122 via wire traces 616 while graphics edge connector 614b connects to MIO B port 214b of GPU 122 via wire traces 618. Each graphics edge connector 614a, 614b is configured for electrical and mechanical connection to a removable interconnect device. In some embodiments, graphics edge connectors 614a and 614b are of identical configuration, allowing them to be used interchangeably.

Graphics adapter 600 in one embodiment is designed for use in distributed rendering systems in which two or more GPUs cooperate to perform different portions of a rendering task. Such systems may be operated, e.g., in a split-frame mode in which each GPU renders a different part of an image, in an alternate-frame mode in which each GPU renders different images in a sequence of images, or in a distributed antialiasing modes as described in above-referenced application Ser. No. ______ (Attorney Docket No. 019680-022300US). In each of these modes, one GPU (the master) receives pixels from another GPU (the slave), and pixel selection logic 300 in the master GPU selects a pixel for display as described above. GPUs on different graphics adapters 600 are advantageously connected via respective graphics edge connectors 614a, 614b using a suitable interconnection device.

In an embodiment of the present invention, a removable interconnection device 620 is constructed and shaped such that it can connect graphics edge connectors 614a and 614b of the same graphics adapter 600, as shown in FIG. 6. Interconnect device 620 can be, e.g., a ribbon cable or a PCB with wire traces printed along its length, with receptacles at either end for receiving a graphics edge connector 614a, 614b, allowing the two graphics edge connectors 614a, 614b to be connected to each other.

In this embodiment, interconnection device 620 exploits the timing characteristics of the distributed-rendering system supported by graphics adapter 600 to establish a pixel transfer path 400 (FIG. 4). More specifically, in a distributed rendering configuration, a pixel transfer path from MIO B port 214b of GPU 122 to an MIO A port (or MIO B port) of a GPU on a different graphics adapter 600 has a characteristic transfer time, resulting from the lengths of wire traces 618 and/or 616 and the interconnect device between the two adapters, as well as any electronic components (FIFOs, latches, etc.) that may be included along any segment of the transfer path. In distributed rendering operations, the transfer of pixels from the display head of the slave GPU to the display head of the master GPU is advantageously coordinated such that the pixels from the slave GPU and master GPU arrive at the display head of the master GPU at substantially the same time (e.g., during the same clock cycle).

As long as interconnection device 620 provides a transmission time matching that of a distributed-rendering interconnection device that connects different GPUs, the pixel transfer path provided by interconnection device 620 delivers signals to MIO A port 214a with the correct timing. Thus, implementation of internally distributed AA using an external interconnection device requires no internal modifications to a GPU 122 or an adapter card 600 that was originally designed for distributed rendering.

It will be appreciated that the graphics adapters and interconnection devices described herein are illustrative and that variations and modifications are possible. The shape, layout, and material composition of the adapters and interconnection devices may be modified from those shown and described herein, and any communication protocol may be implemented for transferring data between MIO ports.

In one alternative embodiment, interconnection device 620 might be implemented as part of PCB 602, e.g., using wire traces to connect path 618 to path 616. In this embodiment, control devices (e.g., a removable jumper or a driver-controlled switch) are advantageously used to enable or disable data transfers from path 618 to path 616 or vice versa.

It should also be noted that in some embodiments the presence of interconnection device 620 or other external connection between two MIO ports of the same GPU does not automatically enable internally distributed AA. As described above, the operation of pixel selection logic 300 determines whether internally distributed AA is performed; operation of pixel selection logic 300 is controlled via the graphics driver.

In another alternative embodiment, the pixel transfer path used for internally distributed AA is built within the GPU. FIG. 7 is a block diagram of a GPU 700 according to one such embodiment of the present invention. GPU 700 is generally similar to GPU 122 of FIG. 4, and like reference numbers have been used to identify corresponding components. Unlike GPU 122, GPU 700 includes an internal pixel transfer path connecting an output path 702 of display head B 206b to an external pixel input path 704 of display head A 206a.

In this embodiment, the pixel transfer path includes a selection unit (e.g., a multiplexer) 706 that selects between the pixel from display head B 206b and a pixel received on a path 708 from one of the MIO ports, e.g., MIO A port 214a, via crossbar 220. The selected pixel is provided to the external pixel input path 704 of display head A 206a.

Selection unit 706 operates in response to a control signal (not explicitly shown). The control signal configures selection unit 706 to select the pixel on path 702 in the event that GPU 700 is operating in internally distributed AA mode and to select the pixel on path 708 in the event that display head A 206a of GPU 700 is operating as a master to another GPU. This control signal may be generated in response to commands issued by the graphics driver, enabling a user (or application developer) to enable or disable internally distributed AA through an appropriate software interface without having to access the graphics hardware.

It should be noted that in this embodiment, path 702 from display head B 206b to the selection circuit 706 may include FIFOs, latches, and other timing control devices so that pixels from display head B 206b reach selection circuit 706 with the same timing as would pixels arriving from an external GPU in a distributed rendering mode. Where this is the case, the operational timing of display head B 206b and display head A 206a is independent of whether the GPU is in a distributed rendering mode or an internally distributed AA mode.

An internal pixel transfer path, while requiring modifications to the GPU, does not require use of any of the GPU's I/O ports. Thus, for instance, display head A 206a of GPU 700 can be slaved to a display head in another GPU, or display head B 206b of GPU 700 can be master to a display head in another GPU while GPU 700 continues to perform internally distributed AA filtering.

It will be appreciated that the internal pixel transfer path described herein is illustrative and that variations and modifications are possible. For instance, a “reverse” pixel transfer path (from display head A 206a to display head B 206b) might be provided in addition to the path shown.

### Further Embodiments

As described above, embodiments of the present invention provide a single GPU with the capability of using readout techniques and components generally associated with distributed rendering across multiple GPUs to generate AA-filtered images. Via a suitable graphics driver interface, an end user of an appropriately configured GPU can elect to enable internally distributed AA for any graphics program, regardless of the AA (or lack thereof) provided in the program itself. Where the program provides AA, internally distributed AA as described herein can be used to increase (e.g., double) the AA resolution.

While the invention has been described with respect to specific embodiments, one skilled in the art will recognize that numerous modifications are possible. For instance, although the invention has been described with reference to AA filtering, the coupling between display heads of a single GPU described herein may be used in other ways.

In one alternative embodiment, internally distributed filtering can be used to generate stereo anaglyphs. As is known in the art, a stereo anaglyph overlays a left-eye view and a right-eye view of a scene to produce a single image. Typically, different color filters are applied to the left-eye pixels and the right-eye pixels; for instance, the right-eye pixels may be filtered with a red-pass filter while the left-eye pixels are filtered using a blue/green-pass filter. Due to a viewport or viewpoint offset between the left-eye and right-eye views, the left-eye pixel and right-eye pixel corresponding to the same point in the scene are in different places in the anaglyph. Thus, to the naked eye, an anaglyph appears as a double image with distorted colors. To view the image properly, a viewer dons special glasses with a left lens that filters out the colors used for right-eye pixels and a right lens that filters out the colors used for left-eye pixels.

Referring to FIG. 4, the rendering pipeline (not shown) of GPU 122 can generate both views, storing the left-eye view in frame buffer A and the right-eye view in frame buffer B (or vice versa). Display pipeline B 402b and display head B 206b deliver the right-eye pixels to display head A 206a as pixels P_{B} while display pipeline A 402a delivers the left-eye pixels to display head A 206a as pixels P_{A}. In display head A 206a, pixel combiner 308 (FIG. 3) blends the pixels appropriately to produce the anaglyph.

Internally distributed filtering can also be used to generate transitional effects such as fade-in, fade-out, or dissolve. For instance, frame buffer B may store an image that is fading out while frame buffer A stores an image that is fading in. At each frame, pixel combiner 308 adjusts the relative weights of the pixels from frame buffer A and frame buffer B, so that the image from frame buffer A gradually increases to full intensity while the image in frame buffer B fades to zero intensity. (If the image in frame buffer B is a solid color field, the effect is a fade-in; if the image in frame buffer A is a solid color, the effect is a fade-out.) The smoothness of the transition depends in part on the number of different weighted averages of pixels P_{A} and P_{B} pixel combiner 308 is capable of forming, which is a matter of design choice.

In another embodiment, such transitional effects can be achieved using internally distributed filtering in combination with a lookup table in each display head. As is known in the art, a display head often includes a lookup table that converts the internal pixel representation to a color intensity value appropriate for a display device, and different values can be loaded into the lookup table can be reloaded from time to time. Fade out (or fade in) can be achieved by reducing (or increasing) the color intensity of the values in the lookup table from one frame to the next. Thus, to dissolve from an image in frame buffer B to an image in frame buffer A, conventional fade-out lookup tables could be applied in display head B while conventional fade-in lookup tables are applied in display head A. Pixel combiner 308 would combine the two images with constant (e.g., equal) weights to create the dissolve effect.

In other embodiments, pixel transfer between display heads of the same GPU is used to implement display features that do not involve blending. For instance, pixel transfer between display heads can be used to control an LCD overdrive (also referred to in the art as “LCD feed-forward” or “response time compensation” (RTC)) function. As is known in the art, an LCD screen can be made to respond faster if the signals driving the pixels are adjusted from frame to frame based in part on the desired new intensity and in part on the difference between the desired new intensity and the previous intensity.

To implement an LCD overdrive function, frame buffer A can be used to store pixels of a new image while frame buffer B stores pixels of a previous image. Display head B delivers the previous pixel values to display head A, and pixel combiner 308 of display head A can be configured to compute an overdrive value based on the new value and the previous value, e.g., using conventional techniques for computing an LCD overdrive signal.

A pixel transfer between display heads of a GPU can also be used for generating composite images. For instance, frame buffer B may contain pixels for an overlay image to be overlaid on part of an image stored in frame buffer A. Display head B delivers overlay pixels to display head A, and pixel selection logic 300 in display head A selects the internal pixel except in the overlay region, where the external pixel is selected.

Thus, although the invention has been described with respect to specific embodiments, it will be appreciated that the invention is intended to cover all modifications and equivalents within the scope of the following claims.

What is claimed is:

1. A graphics processing device comprising:
a first display head configured to generate a first output pixel, the first display head being disposed within an integrated circuit;
a second display head configured to generate a second output pixel, the second display head being disposed within the integrated circuit, the second display head including:
a first input path configured to receive an external pixel;
a second input path configured to receive an internal pixel;
a pixel combiner coupled to the first input path and the second input path and configured to blend the external pixel and the internal pixel to generate a blended pixel; and
a selection circuit configured to select one of the external pixel, the internal pixel, or the blended pixel as a second output pixel; and
a pixel transfer path configurable to deliver the first output pixel from the first display head to the first input path of the second display head such that the first output pixel is received by the first input path as the external pixel.

2. The graphics processing device of claim 1 wherein the pixel transfer path is disposed within the integrated circuit.

3. The graphics processing device of claim 1 wherein at least a portion of the pixel transfer path is external to the integrated circuit.

4. The graphics processing device of claim 3 wherein the pixel transfer path includes a removable connector.

5. The graphics processing device of claim 1 further comprising:
a first display pipeline configured to generate a first pixel and to deliver the first pixel to the first display head; and
a second display pipeline configured to generate a second pixel and to deliver the second pixel to the second display head.

6. The graphics processing device of claim 5 further comprising:
a rendering pipeline configured to generate first and second versions of a frame to be displayed, the first and second versions being different from each other in at least one respect,
wherein the first display pipeline is configured to generate the first pixel based on the first version of the frame, the second display pipeline is configured to generate the second pixel based on the second version of the frame, and the selection circuit in the second display head is configured to select the blended pixel as the second output pixel.

7. The graphics processing device of claim 6 wherein the first and second versions of the frame differ with respect to a viewport offset.

8. The graphics processing device of claim 6 wherein the first and second versions of the frame differ with respect to a sampling pattern.

9. A graphics subsystem comprising:
a graphics adapter having a pixel output connector and a pixel input connector;
a graphics processor having a pixel output port communicably coupled to the pixel output connector and a pixel input port communicably coupled to the pixel input connector; and
a removable connector unit adapted to connect the pixel output connector of the graphics adapter to the pixel input connector of the graphics adapter.

10. The graphics subsystem of claim 9 wherein the pixel output port is a multipurpose input/output port configured for use as an output port.

11. The graphics subsystem of claim 9 wherein the pixel input port is a multipurpose input/output port configured for use as an input port.

12. The graphics subsystem of claim 9 wherein:
the graphics adapter further has a display connector adapted to be connected to a display device; and
the graphics processor has a display output port communicably coupled to the display output port.

13. The graphics subsystem of claim 12 wherein the graphics processor includes:
a first display head configured to deliver a first pixel stream to the pixel output port; and
a second display head configured to blend pixels received at the pixel input port with pixels of a second pixel stream and to deliver the blended pixels to the display output port,
wherein when the removable connector unit connects the pixel output connector to the pixel input connector, the second display head blends pixels of the first pixel stream with pixels of the second pixel stream.

14. A method of generating an image, the method comprising:
rendering a first set of input pixels and a second set of input pixels for the image using a rendering pipeline of a graphics processor, wherein a first rendering operation used to render the first set of input pixels differs in at least one respect from a second rendering operation used to render the second set of input pixels;
delivering the first set of input pixels to a first display head of the graphics processor;
delivering the second set of input pixels to a second display head of the graphics processor;
delivering the first set of input pixels from the first display head to the second display head; and
in the second display head, blending corresponding pixels of the first set of input pixels and the second set of input pixels to generate a set of output pixels.

15. The method of claim 14 wherein the first and second rendering operations differ with respect to a sampling pattern applied to each pixel.

16. The method of claim 14 wherein the first and second rendering operations differ with respect to a viewport offset of the image being rendered.

17. The method of claim 14 further comprising:
delivering the first set of output pixels to a display device.
